(19) United States
(12) Patent Application Publication
(10) Pub. No.: US 2015/0370294 A1
(43) Pub. Date: Dec. 24, 2015

(54) ADAPTIVE OPTIMIZATION OF DATA CENTER COOLING

(71) Applicant: Lenovo Enterprise Solutions, Singapore (SG)

(72) Inventors: DIANE S. BUSCH, DURHAM, NC (US); TROY W. GLOVER, RALEIGH, NC (US); WILLIAM M. MEGARITY, RALEIGH, NC (US); WHITCOMB R. SCOTT, III, CHAPEL HILL, NC (US)

(21) Appl. No.: 14/308,026

(22) Filed: Jun. 18, 2014

(51) Int. Cl. G06F 1/20; G06F 1/32

(52) U.S. Cl. CPC G06F 1/206; G06F 1/3206; G06F 1/324; G06F 1/3287

(57) ABSTRACT

An electronic system comprises: at least one electronic component; a cooling system condition receiver, wherein the cooling system condition receiver is capable of receiving a condition signal, and wherein the condition signal describes a current condition of a cooling system that provides conditioned air to an ambient environment of the electronic system; and a throttle, wherein the throttle, in response to the cooling system condition receiver receiving the condition signal that describes the current condition of the cooling system, adjusts an amount of heat generated by said at least one electronic component by throttling back operations of said at least one electronic component.

### BACKGROUND

The present disclosure relates to the field of electronic devices, and specifically to electronic devices that operate within a confined space, such as a data center room. Still more particularly, the present disclosure relates to optimizing the temperature of the data center room for efficient cooling of the electronic devices.

Electronic devices include computing devices, such as personal computers, servers, blade servers, blade server chassis that hold multiple blade servers, etc. Such computing devices have cooling requirements that, if not met, may result in damage to the computing devices.

### SUMMARY

In one embodiment of the present invention, an electronic system comprises: at least one electronic component; a cooling system condition receiver, wherein the cooling system condition receiver is capable of receiving a condition signal, and wherein the condition signal describes a current condition of a cooling system that provides conditioned air to an ambient environment of the electronic system; and a throttle, wherein the throttle, in response to the cooling system condition receiver receiving the condition signal that describes the current condition of the cooling system, adjusts an amount of heat generated by said at least one electronic component by throttling back operations of said at least one electronic component.

In one embodiment of the present invention, a method and/or computer program product responds to a failure in a cooling system for an ambient environment of an electronic system. A cooling system condition receiver receives a condition signal, which describes a current condition of a cooling system that provides conditioned air to an ambient environment of an electronic system. In response to the condition signal describing a failure in the cooling system, a hardware throttle device throttles back operations of the electronic system.

### BRIEF DESCRIPTION OF THE SEVERAL VIEWS OF THE DRAWINGS

FIG. 1 depicts an exemplary system and network which may be used to implement the present invention;

FIG. 2 depicts an exemplary data center room in which the present invention may be implemented/utilized;

FIG. 3 illustrates an exemplary blade chassis in which the present invention may be implemented; and

FIG. 4 is a high level flow chart of one or more exemplary steps taken by one or more processors to automatically throttle back one or more electronic devices in response to a failure of a room cooling system.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

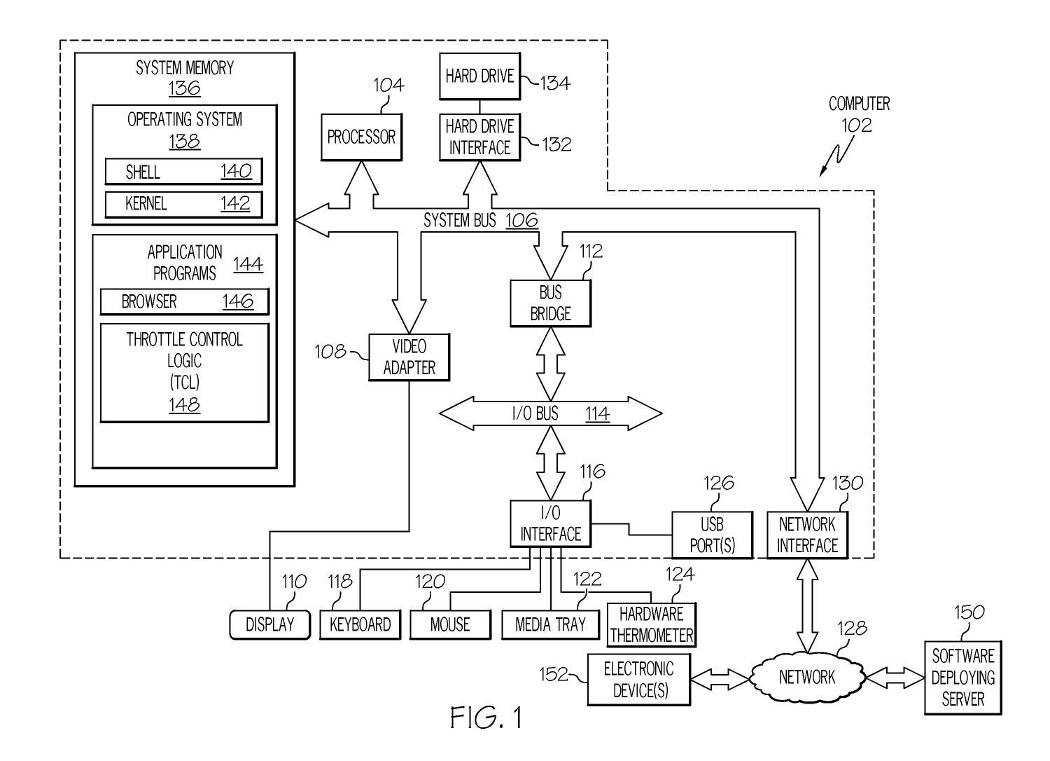

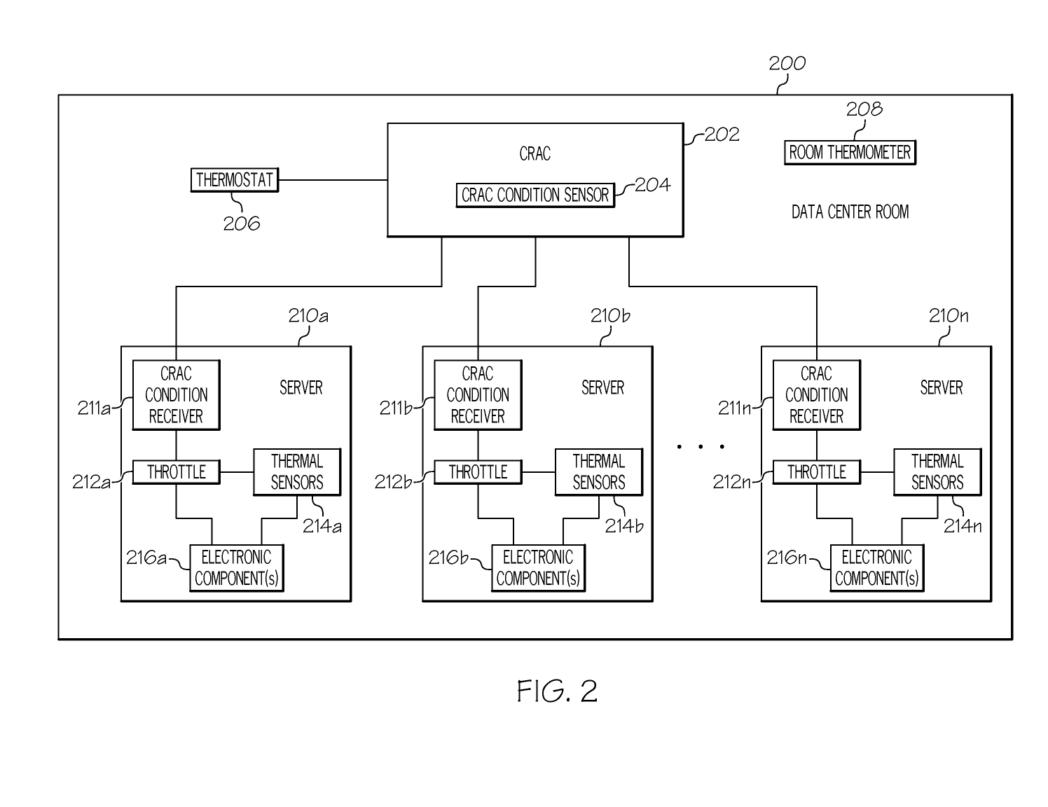

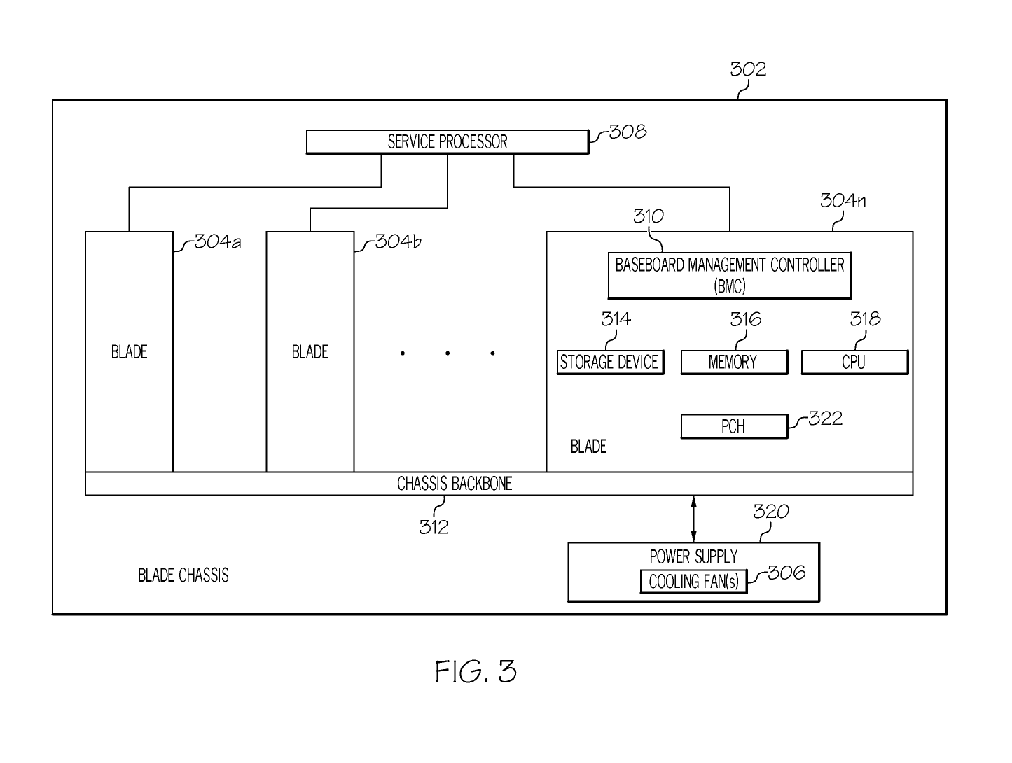

With reference now to the figures, and in particular to FIG. 1, there is depicted a block diagram of an exemplary system and network that may be utilized by and/or in the implementation of the present invention. Note that some or all of the exemplary architecture, including both depicted hardware and software, shown for and within computer 102 may be utilized by software deploying server 150 and/or electronic devices 152, as well as servers 210a-210n and/or electronic component(s) 216a-216n depicted in FIG. 2, and/or blades 304a-304n and/or service processor 308 and/or Baseboard Management Controller (BMC) 310 depicted in FIG. 3.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a hardware thermometer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and/or other computer systems.

Application programs 144 in computer 102's system memory (as well as software deploying server 150's system memory) also include a Throttle Control Logic (TCL) 148. TCL 148 includes code for implementing the processes described below, including those described and/or referenced in FIGS. 2-4. In one embodiment, computer 102 is able to download TCL 148 from software deploying server 150, including in an on-demand basis, wherein the code in TCL 148 is not downloaded until needed for execution. Note further that, in one embodiment of the present invention, software deploying server 150 performs all of the functions associated with the present invention (including execution of TCL 148), thus freeing computer 102 from having to use its own internal computing resources to execute TCL 148.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

With reference now to FIG. 2, an exemplary data center room 200 in which the present invention may be implemented/utilized is depicted. Data center room 200 is a room (i.e., in one embodiment an enclosed space) that is cooled and/or heated by a Computer Room Air Conditioner (CRAC) 202. The CRAC system 202 is a mechanical air cooling system (i.e., composed of refrigeration units, fans, air ducts, plenums, etc.) that provides refrigerated (cooled) and/or heated air to the data center room 200 via a plurality of air outlets (not shown). In one embodiment, the cooled/heated air provided by the CRAC system 202 is distributed uniformly throughout the data center room 200. In another embodiment, the cooled/heated air from the CRAC system 202 is unevenly channeled by adjusting air registers (vents) and duct valves, such that one area/device within the data center room 200 receives more or less conditioned air than another area/device within the data center room 200.

Within (or communicatively coupled to) CRAC 202 is a CRAC condition sensor 204. CRAC condition sensor 204 includes hardware logic that monitors the operation of the CRAC 202. For example, CRAC condition sensor 204 may include a power sensor that detects if power has been cut off from the fans and/or other hardware components of CRAC 202.

Similarly, CRAC condition sensor 204 may include logic that determines whether or not the CRAC 202 is able to provide cooled air at a temperature reflected by a thermostat 206 for the data center room 200. That is, if the CRAC 202 is under-sized for the amount of electronic devices that need to be cooled within the data center room 200, then there will be a difference between the temperature setting selected at the thermostat 206 and the actual temperature of the data center room 200 (as detected by a room thermometer 208).

Thus, CRAC condition sensor 204 includes hardware logic that is able to identify any performance problems with the CRAC 202, including but not limited to complete failures, partial failures, sub-optimal performance, etc.

As depicted, multiple electronic devices are located within the data center room 200. In the illustrative example, these electronic devices are servers 210a-210n, where “n” is an integer. Servers 210a-210n are referred to herein as servers, systems, and/or devices.

Within each of the servers 210a-210n is a CRAC condition receiver 211 (depicted as CRAC condition receivers 211a-211n). The CRAC condition receivers 211a-211n are designed to receive a CRAC condition signal from the CRAC condition sensor 204. For example, if the CRAC 202 loses power to its fans and/or refrigerant compressors, or if the CRAC 202 is unable to provide cooling levels that are input into the thermostat 206, then an error signal is generated.

Receipt of the error signal from the CRAC condition sensor 204 causes a throttle (e.g., one or more of the depicted throttles 212a-212n) to send a control signal to one or more components (depicted as electronic component(s) 216a-216n) to throttle back/down, in order to generate less heat. In one embodiment, throttles 212a-212n are hardware devices (e.g., processors) that control (i.e., throttle up or down) operations performed by one or more of the electronic component(s) 216a-216n.

Examples of throttling back include, but are not limited to, decreasing the clock speed of a central processing unit (CPU) within one or more of the servers 210a-210n, slowing down data traffic to and from memory and/or a hard drive within one or more of the servers 210a-210n, limiting how much data traffic is allowed to travel on various internal and external busses within one or more of the servers 210a-210n, etc. In one embodiment, throttling back one or more components is performed by turning the component(s) completely off (e.g., powering off, disabling, etc.). By decreasing these operations within one or more of the servers 210a-210n, the heat emitted by one or more of the servers 210a-210n will decrease, although at the expense of a reduction in capacity/functionality for one or more of the servers 210a-210n.

Also within each of the servers 210a-210n is one of the depicted thermal sensors 214a-214n. Thermal sensors 214a-214n are able to detect if the operational temperature of a respective server (from the depicted servers 210a-210n), and more specifically one or more of the depicted electronic component(s) 216a-216n, is too high (i.e., a device is operating at a temperature that is higher than a predetermined nominal (normal) temperature).

In one embodiment, the electronic components are one or more computer hardware components. For example, electronic component(s) 216a may be one or more of a central processing unit (CPU), memory, hard drive, input/output (I/O) modem, coprocessor, video card, audio card, etc. Thus, if there is a partial, total, or performance failure of the CRAC 202, one or more of these computer hardware components will be throttled back (i.e., have their operational levels reduced) or turned off completely.

In one embodiment, different servers from servers 210a-210n are selectively throttled back based on various predefined parameters in response to a failure in the CRAC 202.

For example, assume that server 210a is devoted to performing a low-level function, such as backing up non-critical data (e.g., data that has been predetermined to have no effect on performance of a project if that data is lost). Assume further that server 210b is devoted to performing a mission critical function (e.g., runs a life-support system in a hospital). If a message is received from the CRAC condition sensor 204 that the CRAC 202 has suffered a failure (e.g., a complete mechanical shutdown), then throttle 212a is designed to immediately shut down all components of server 210a, while throttle 212b is designed to either let server 210b continue to operate normally, or else reduce the operations of server 210b by a predetermined marginal amount (which still affords at least partial functionality for server 210b).

In one embodiment, each of the servers 210a-210n depicted in FIG. 2 is a blade chassis, such as the blade chassis 302 depicted in FIG. 3. Exemplary blade chassis 302 shown in FIG. 3 contains one or more server blades, depicted as blades 304a to 304n (where “n” is an integer), which are mounted on a chassis backbone 312, and which are powered by a power supply 320. In one embodiment, each of the blades 304 is cooled by one or more fans, such as the depicted cooling fan(s) 306.

Exemplary blade chassis 302 is managed by an Integrated Management Module (IMM). This IMM, not shown, is a combination hardware device that performs (and replaces) the functions of the depicted Service Processor (SP) 308 and the depicted Baseboard Management Controller (BMC) 310, as well as a non-depicted video controller, super Input/Output (I/O) interface, and Remote Supervisor Adapter (RSA) for remotely controlling operations of a server. Thus, in a preferred embodiment an IMM performs the functions of not only the SP 308 and BMC 310 shown in FIG. 3, but also the CRAC condition receivers 211a-211n and throttles 212a-212n shown in FIG. 2.

Service Processor (SP) 308 is a hardware-based processor, also known as a management processor. Service processors, also known as management processors, work with hardware instrumentation and systems management software to provide problem notification and resolution (e.g., to a throttle such as throttle 212n shown in FIG. 2). SP 308 also allows different blades from blades 304a-304n (or servers from servers 210a-210n shown in FIG. 2) to communicate among themselves. SP 308 also enables blades 304a-304n (or servers from servers 210a-210n shown in FIG. 2) to communicate with the CRAC 202 shown in FIG. 2, by supporting functions of the CRAC condition receivers 211a-211n shown in FIG. 2.

BMC 310 (a copy/version of which is found within each of the blades 304a-304n) is a specialized microcontroller on a motherboard, such as that found in blade 304n. That is, BMC 310 manages an interface between system management software within blade 304n and platform hardware found within blade 304n. Thus, sensors (including thermal sensors 214a-214n shown in FIG. 2) within blade 304n, which report on such statuses/parameters as temperature, cooling fan speeds, power status, local Operating System (OS) statuses, etc., provide information describing operations of the blade 304n. In other words, BMC 310 is a specialized microcontroller that manages the overall health and environment of a blade such as blade 304n. This management includes both the monitoring as well as the control of cooling fans, power supplies, other hardware devices, as well as operations of components of blade 304n, such as the electronic component(s) 216a-216n shown in FIG. 2.

Also within exemplary blade 304n is a storage device 314, a memory 316, a Central Processing Unit (CPU) 318, and a Platform Control Hub (PCH) 322. Examples of storage device 314 include, but are not limited to, a hard disk drive, a flash drive, etc. Examples of memory 316 include, but are not limited to a Single In-line Memory Module (SIMM), a Dual In-line Memory Module (DIMM), etc. Examples of CPU 318 include, but are not limited to, a main processor, a multi-core processor, a co-processor, etc. PCH 322 is a chip that controls data paths, clocking, interfaces, etc. for one or more electronic components of blade 304n, including but not limited to storage device 314, memory 316, and/or CPU 318. Each of these components is capable of being selectively throttled back by a throttle, such as one or more of the throttles 212a-212n shown in FIG. 2.

Thus, as depicted in FIG. 1-FIG. 3, one embodiment of the present invention is an electronic system, such as one or more of the servers 210a-210n depicted in FIG. 2. The electronic system includes at least one electronic component, such as one or more of the electronic components 216a depicted in FIG. 2 and/or one or more of the blades 304a-304n depicted in FIG. 3 (assuming that a blade chassis such as blade chassis 302 in FIG. 3 is viewed as being a server from servers 210a-210n in FIG. 2).

The electronic system also includes a cooling system condition receiver (e.g., CRAC condition receiver 211a shown in FIG. 2). This cooling system condition receiver is capable of receiving a condition signal (e.g., from CRAC condition sensor 204 in FIG. 2). The condition signal describes a current condition of a cooling system that provides conditioned air to an ambient environment of the electronic system (e.g., CRAC 202 shown in FIG. 2).

The electronic system also includes a throttle (e.g., throttle 212a shown in FIG. 2). This throttle, in response to the cooling system condition receiver receiving the condition signal that describes the current condition of the cooling system, adjusts an amount of heat generated by said at least one electronic component by throttling back operations of said at least one electronic component. That is, if the current condition of the cooling system is faulty (i.e., the CRAC 202 is broken), then one or more electronic components within the electronic system are throttled back, such that less heat is generated by the electronic system.

In one embodiment of the present invention, the electronic component of the electronic system is a processor. In this embodiment, the electronic system further comprises a hardware management module, such as the Integrated Management Module (IMM) described in FIG. 3. As stated above, this IMM (not shown in FIG. 3) is a combination device that performs the functions of the depicted Service Processor (SP) 308 and the depicted Baseboard Management Controller (BMC) 310, as well as the CRAC condition receivers 211a-211n and throttles 212a-212n shown in FIG. 2. Thus, this hardware management module (e.g., the IMM) throttles back operations of the processor by reducing a clock speed of the processor. In another embodiment, the IMM throttles back operations of the processor by reducing a throughput of operations performed by the processor.

In another embodiment, the electronic component is a hard drive, and the IMM throttles back operations of the hard drive by reducing a read/write speed for read/write operations performed by the hard drive.

As described herein, in one embodiment of the present invention, the condition signal (received from the CRAC condition sensor 204 shown in FIG. 2) describes a total failure of the cooling system, while in another embodiment the condition signal describes a partial failure of the cooling system.

As depicted in FIG. 3, in one embodiment of the present invention, the electronic device is a server chassis (e.g., blade chassis 302) that contains multiple server blades (e.g., blades 304a-304n).

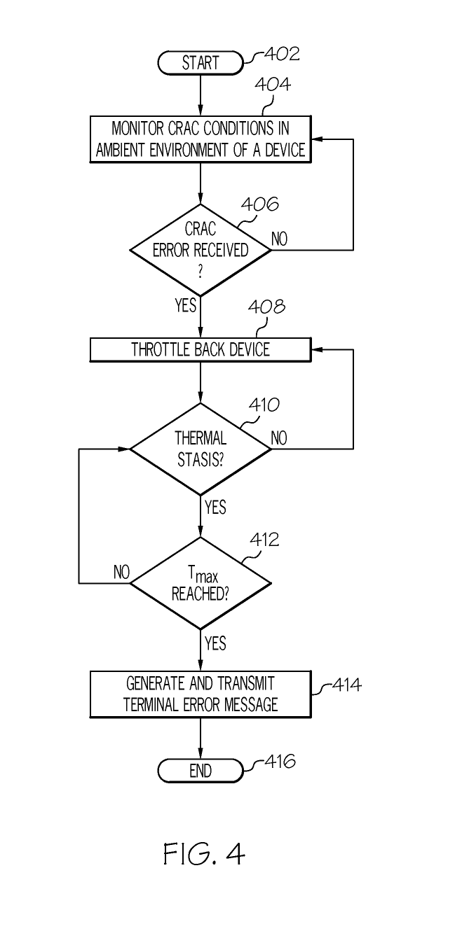

With reference now to FIG. 4, a high level flow chart of one or more exemplary steps taken by one or more processors to respond to a failure in a cooling system for an ambient environment of an electronic system is presented.

After initiator block 402, Computer Room Air Conditioner (CRAC) conditions are monitored (block 404). That is, the performance of the CRAC is monitored, in order to identify whether or not the CRAC is operational (or else shut down), if it is providing adequate levels of cooling to a server room, etc.

As depicted in query block 406, a determination is made as to whether or not a condition signal has been received by a cooling system condition receiver in the electronic system. As described herein, this condition signal describes a current condition of a cooling system (e.g., CRAC 202 shown in FIG. 2) that provides conditioned air to an ambient environment (e.g., within data center room 200 shown in FIG. 2) of an electronic system (e.g., one or more of the servers 210a-210n shown in FIG. 2).

If the condition signal (e.g., a CRAC error signal) describes a failure (either total, partial, or performance-based) in the cooling system, then a hardware throttle device (e.g., one or more of the throttles 212a-212n shown in FIG. 2) will throttle back operations of the electronic system (block 408).

In one embodiment of the present invention, the method further comprises monitoring, by an ambient environment thermal sensor (e.g., room thermometer 208 in FIG. 2), a temperature of the ambient environment of the electronic system (i.e., the “room temperature” of the data center room 200). A component thermal sensor (e.g., one of the thermal sensors 214a-214n) detects a temperature of the electronic system. In response to the temperature of the electronic system exceeding the temperature of the ambient environment of the electronic system, then a hardware throttle device (e.g., one of the throttles 212a-212n shown in FIG. 2) will further throttle back operations of the electronic system.

With reference now to query block 410 in FIG. 4, a determination is made as to whether or not there is a thermal stasis between the electronic system and the room. Thermal stasis is defined as a state that is reached when a difference between the temperature of the electronic device and the temperature of the ambient fluid (e.g., air) within the room is such that the ambient fluid within the room temperature is able to convect heat away from the electronic device. That is, while in a stasis state with the ambient room air, the electronic device is able to dissipate/discharge heat into the room (per known laws of thermodynamics). However, if the temperature within the room is too high to accept heat from the electronic device, then there is no stasis state, and the electronic device must be further throttled back (block 408), in order to reduce the amount of heat being generated by the electronic device (thus reducing the amount/level of heat that needs to be dissipated from the electronic device).

As depicted in query block 412, a point might be reached at which the temperature of the room is so high that the maximum temperature (Tₘₐₓ) of the electronic device is reached. Tₘₐₓ is defined as a maximum operating temperature for the electronic device that, if exceeded, will cause damage to the electronic device. That is, in this scenario the room temperature is so high that the temperature of the electronic device has become dangerously high, since it is unable to dissipate heat into the room. Thus, no amount of throttling, short of turning off the electronic device, will protect the electronic device. In this case, a terminal error message is generated and transmitted (e.g., to the electronic device or to a control system), indicating that Tₘₐₓ for the electronic device has been reached. In one embodiment, this terminal error message shuts down the electronic device. The flow chart ends at terminator block 416.

In one embodiment of the present invention, the method further comprises monitoring, by a component thermal sensor (e.g., one of the thermal sensors 214a-214n in FIG. 2) a temperature of the electronic system. In response to the temperature of the electronic system exceeding a predefined threshold value, the hardware throttle device (e.g., one of the throttles 212a-212n in FIG. 2) receives an instruction to terminate (i.e., shut down) the operations of the electronic system.

In one embodiment of the present invention, the electronic system includes a processor. In this embodiment, the method further comprises throttling back, by a hardware management module, operations of the processor by reducing a clock speed of the processor.

In one embodiment of the present invention, the electronic system includes a processor. In this embodiment, the method further comprises throttling back, by a hardware management module, operations of the processor by reducing a throughput of operations performed by the processor.

In one embodiment of the present invention, the electronic system includes a hard drive. In this embodiment, the method further comprises throttling back, by a hardware management module, operations of the hard drive by reducing a read/write speed for read/write operations performed by the hard drive. For example, normal operating conditions may be for a read/write head to move and a disk to spin at speeds that allow the hard drive to access/read/write 100 Megabits per second (Mbs). By slowing down the disk and how fast the read/write head moves, the hard drive can be throttled down to a much slower throughput rate (e.g., 10 Mbs), and less heat will be generated by this throttling back.

In one embodiment of the present invention, the condition signal from the CRAC 202 describes a failure, either partial or total, of the cooling system. As a further embodiment, assume that the electronic system is a plurality of server chassis that each contain multiple server blades. In this further embodiment, one or more processors (or other hardware devices) will selectively throttle back, in response to receiving the condition signal that describes the failure of the cooling system, a server chassis from the plurality of server chassis that is generating more heat than other server chassis from the plurality of server chassis. That is, assume that there are three servers 210a-210n in a data center room 200 (see FIG. 2), and that CRAC 202 has suffered a failure. If server 210a is generating the most heat of the three servers 210a-210n, then server 210a will be shut down first. If the data center room 200 continues to be too warm to cool servers 210b-210n, then the next hottest server (e.g., server 210b) will be shut down, leaving all of the cool air within data center room 200 available to server 210n.

As described herein, in another embodiment, selecting which of the servers 210a-210n are to be shut down and which are to be left up and running depends on how critical the operations of the different servers 210a-210n are to a particular project, enterprise mission, health and safety, etc. That is, if loss of a particular server from servers 210a-210n will not adversely affect (i.e., beyond a predetermined performance level—such as a service level agreement) an operation, then that particular server will be sacrificed (turned off) first.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. An electronic system comprising:
at least one electronic component;
a cooling system condition receiver, wherein the cooling system condition receiver is capable of receiving a condition signal, and wherein the condition signal describes a current condition of a cooling system that provides conditioned air to an ambient environment of the electronic system; and
a throttle, wherein the throttle, in response to the cooling system condition receiver receiving the condition signal that describes the current condition of the cooling system, adjusts an amount of heat generated by said at least one electronic component by throttling back operations of said at least one electronic component.

2. The electronic system of claim 1, wherein said at least one electronic component is a processor, and wherein the electronic system further comprises:
a hardware management module, wherein the hardware management module throttles back operations of the processor by reducing a clock speed of the processor.

3. The electronic system of claim 1, wherein said at least one electronic component is a processor, and wherein the electronic system further comprises:
a hardware management module, wherein the hardware management module throttles back operations of the processor by reducing a throughput of operations performed by the processor.

4. The electronic system of claim 1, wherein said at least one electronic component is a hard drive, and wherein the electronic system further comprises:
a hardware management module, wherein the hardware management module throttles back operations of the hard drive by reducing a read/write speed for read/write operations performed by the hard drive.

5. The electronic system of claim 1, wherein the condition signal describes a total failure of the cooling system.

6. The electronic system of claim 1, wherein the condition signal describes a partial failure of the cooling system.

7. The electronic system of claim 1, wherein the electronic system is a server chassis that contains multiple server blades.

8. A method of responding to a failure in a cooling system for an ambient environment of an electronic system, the method comprising:
receiving, by a cooling system condition receiver, a condition signal, wherein the condition signal describes a current condition of a cooling system that provides conditioned air to an ambient environment of an electronic system; and
in response to the condition signal describing a failure in the cooling system, throttling back, by a hardware throttle device, operations of the electronic system.

9. The method of claim 8, further comprising:
monitoring, by an ambient environment thermal sensor, a temperature of the ambient environment of the electronic system;
monitoring, by a component thermal sensor, a temperature of the electronic system; and
in response to the temperature of the electronic system exceeding the temperature of the ambient environment of the electronic system, further throttling back, by the hardware throttle device, operations of the electronic system.

10. The method of claim 8, further comprising:
monitoring, by a component thermal sensor, a temperature of the electronic system; and
in response to the temperature of the electronic system exceeding a predefined threshold value, issuing, by the hardware throttle device, an instruction to terminate the operations of the electronic system.

11. The method of claim 8, wherein the electronic system comprises a processor, and wherein the method further comprises:
throttling back, by a hardware management module, operations of the processor by reducing a clock speed of the processor.

12. The method of claim 8, wherein the electronic system comprises a processor, and wherein the method further comprises:
throttling back, by a hardware management module, operations of the processor by reducing a throughput of operations performed by the processor.

13. The method of claim 8, wherein the electronic system comprises a hard drive, and wherein the method further comprises:
throttling back, by a hardware management module, operations of the hard drive by reducing a read/write speed for read/write operations performed by the hard drive.

14. The method of claim 8, wherein the condition signal describes a total failure of the cooling system.

15. The method of claim 14, wherein the electronic system is a plurality of server chassis that each contain multiple server blades, and wherein the method further comprises:
selectively throttling back, by one or more processors and in response to receiving the condition signal that describes the total failure of the cooling system, a server chassis from the plurality of server chassis that is generating more heat than other server chassis from the plurality of server chassis.

16. A computer program product for responding to a failure in a cooling system for an ambient environment of an electronic system, the computer program product comprising a computer readable storage medium having program code embodied therewith, the program code readable and executable by a processor to perform a method comprising:
receiving, by a cooling system condition receiver, a condition signal, wherein the condition signal describes a current condition of a cooling system that provides conditioned air to an ambient environment of an electronic system; and
in response to the condition signal describing a failure in the cooling system, throttling back, by a hardware throttle device, operations of the electronic system.

17. The computer program product of claim 16, wherein the method further comprises:
monitoring, by an ambient environment thermal sensor, a temperature of the ambient environment of the electronic system;
monitoring, by a component thermal sensor, a temperature of the electronic system; and
in response to the temperature of the electronic system exceeding the temperature of the ambient environment of the electronic system, further throttling back, by the hardware throttle device, operations of the electronic system.

18. The computer program product of claim 16, wherein the method further comprises:
monitoring, by a component thermal sensor, a temperature of the electronic system; and
in response to the temperature of the electronic system exceeding a predefined threshold value, issuing, by the hardware throttle device, an instruction to terminate the operations of the electronic system.

19. The computer program product of claim 16, wherein the electronic system comprises a processor, and wherein the method further comprises:
throttling back, by a hardware management module, operations of the processor by reducing a clock speed of the processor.

20. The computer program product of claim 16, wherein the electronic system is a plurality of server chassis that each contain multiple server blades, and wherein the method further comprises:
selectively throttling back, by one or more processors and in response to receiving the condition signal that describes the failure of the cooling system, a server chassis from the plurality of server chassis that is generating more heat than other server chassis from the plurality of server chassis.
